(19) United States
(12) Patent Application Publication
(10) Pub. No.: US 2005/0268543 A1
(43) Pub. Date: Dec. 8, 2005

(54) Mobile furnace for heat treatment of agricultural materials in milling bins

(75) Inventors: Patrick Charles Hicks, Kenosha, WI (US); Dominic A. Garcia, Kenosha, WI (US)

Correspondence Address: CARGILL, INC., 15407 MCGINTY ROAD WEST, WAYZATA, MN, 55391-2399, US

(73) Assignee: Cargill, Inc., Wayzata, MN (US)

(21) Appl. No.: 10/859,590

(22) Filed: Jun. 3, 2004

(51) Int. Cl. A01G 11/00

(52) U.S. Cl. 47/1.42

(57) ABSTRACT

A mobile apparatus for heat treating agricultural material in a milling bin for insect and pest control comprises a frame having a plurality of wheels, an air handling device having an inlet for receiving air and an outlet through which a flow of air is delivered, and a heater having a channel in fluid communication with the air handling device. The heater is capable of heating air in the channel to a temperature of at least about 130° F. The apparatus also include a conduit in fluid communication with the heater for delivering the flow of heated air into the interior of the milling bin, and a controller for maintaining an air temperature within the conduit effective for treating the agricultural material for insect and pest control.

### FIELD OF THE INVENTION

The present invention is directed to methods and devices for treating agricultural materials in milling bins to kill insects and other pests and, more particularly to devices adapted for heat treatments of agricultural materials without the need for chemical fumigants.

### DESCRIPTION OF RELATED ART

When stored for any length of time, both raw and finished agricultural products, primarily grains, may become infested with insects and other living matter. Current fumigation techniques utilize solid and liquid chemicals convertible to gases for passage throughout the silo or other storage area. The primary liquid chemical used is methyl bromide. When mixed with air, the liquid turns into a gas which is then circulated and recirculated throughout the storage area, using expensive equipment. Typically, at least three pounds of the agent are used per one thousand cubic feet of volume in order to achieve an effective concentration of methyl bromide. The liquid fumigant may be used for lightly packed raw and finished products, but in each case equipment and energy are required for circulation of the air and gas mixture, and no recirculation can occur in dense finished products such as flour. Such treatments generally require shutting down plant operations for a period of time. Another drawback is that the conventional structural fumigation processes by the use of methyl bromide alone do not provide for satisfactory kill rates for the target pests at the reduced methyl bromide concentrations now required for environmental reasons. In this respect, tests by environmental agencies have found that use of methyl bromide at such conventional concentrations has the potential to result in toxic residues within protected areas which remain at a level above five parts per million in air samples after the process is completed. This level of residual toxic agent constitutes an unacceptable risk to the persons applying the fumigant as well as residents of structures and workers entering the fumigated area after the process has been completed. Methyl bromide also has been associated with adverse environmental effects such as ozone depletion.

The primary solid chemical used produces phosphine gas when exposed to air. In the case of raw agricultural products, the solid, in the form of pellets or sachets or small bags, is placed directly in the grain in the silos or storage bins. The grain must be constantly turned during the introduction of the chemical, a process which takes up to eight hours and which involves considerable trouble and expense in the physical handling of the product. Once the pellets or bags are evenly distributed throughout the grain, it requires some 72 hours for the chemical to turn into gaseous form, after which there is a powdery residue. At low concentrations, the gas must be maintained three to four weeks, which is unacceptable for structural fumigation. The time may be shortened if the atmosphere is enriched with up to 30% carbon dioxide. However, the temperature of this process is critical as phosphine gas is explosive. Therefore, raising the temperature of the fumigant gas to decrease the concentration of the fumigant gas by weight is not practical for safety reasons in structural fumigation.

It would be desirable to develop an effective alternative to current milling bin fumigation treatments, preferably a treatment that does not involve the use of potentially hazardous agents and preferably one which can substantially eliminate insects and other pests at a lower cost than that associated with current fumigation techniques. It would be especially desirable to develop a device capable of treating milling bins without the need of shutting down plant operations.

### SUMMARY OF THE INVENTION

The present invention, according to one aspect, is directed to a mobile apparatus for heat treating agricultural material in a milling bin for insect and pest control. The apparatus comprises a frame having a plurality of wheels, an air handling device having an inlet for receiving air and an outlet through which a flow of air is delivered, and a heater having a channel in fluid communication with the air handling device. The heater is capable of heating air in the channel to a temperature of at least about 130° F. The apparatus also includes a conduit in fluid communication with the heater for delivering the flow of heated air into the interior of the milling bin, and a controller for maintaining an air temperature within the conduit effective for treating the agricultural material for insect and pest control.

According to another aspect, a method of treating agricultural material in a milling bin for insect and pest control comprises placing the mobile apparatus in proximity of the milling bin; placing the conduit in communication with the interior of the milling bin so that heat can be transferred from the conduit to the interior of the milling bin; and providing a flow of heated air through the conduit at a temperature and for a time sufficient to treat agricultural material in the milling bin for insect and pest control. Temperatures of at least 130° F., and preferably at least about 140° F., and heating times of at least about one hour are preferred for this treatment.

The mobile furnace of the present is effective for the treatment of agricultural materials, such as flour or grains, in milling bins to eliminate or substantially eliminate insect and other pests. Advantageously, the treatment can be performed without the need for methyl bromide, phosphine gas, or other potentially hazardous agents. The furnace permits the contents of the bins to be heated to temperatures effective for insect and pest treatment easily and in relatively short periods of time, such that treatments usually can be made without the need of shutting down plant operations. The present invention has the potential to yield cost savings both from the standpoint of avoiding the need to purchase or use chemical fumigants and also by avoiding inefficiencies associated with plant shutdowns during conventional fumigation.

### BRIEF DESCRIPTION OF THE DRAWINGS

The objects, features, and advantages of the invention will be apparent from the following more detailed description of certain embodiments of the invention and as illustrated in the accompanying drawings in which:

FIG. 1A is a schematic illustration of a mobile furnace in accordance with a preferred embodiment of the present invention;

FIG. 1B is end view of the mobile furnace in the embodiment shown in FIG. 1A, showing the adjustable air damper on the connecting tee and the heater outlet with the ductwork and plenum removed;

FIG. 2 is an illustration of a mobile furnace having a heating duct inserted into a filling port of a milling bin; and

FIG. 3 illustrates electric heating coils of the mobile furnace in accordance with a preferred embodiment of the present invention;

### DETAILED DESCRIPTION OF THE INVENTION

The present invention will be described with reference to treating agricultural materials in milling bins. The term “milling bin” is used herein to refer to any type of bulk storage container, such as a bin or silo, conventionally used for receiving and storing raw or finished agricultural products such as rice, oats, wheat, milo, flour, and the like, and should not be construed as being limited to any particular size or configuration of container. A typical milling bin may have, for example, a width of 10 feet, a length of 10 feet, and a depth of 70 feet. It should be understood that these dimensions are merely exemplary and not limiting, as the dimensions of an actual container may vary significantly from these dimensions.

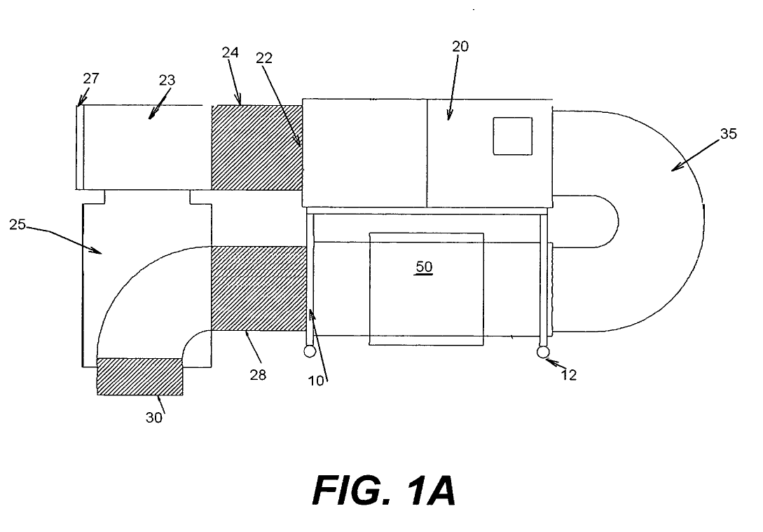

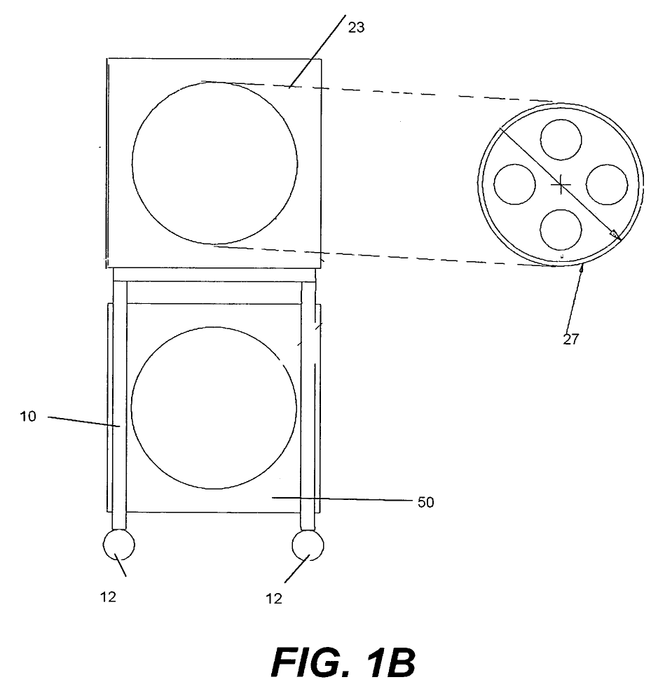

The apparatus preferably is constructed for ease of mobility. With reference to the embodiment illustrated in FIG. 1A, a frame 10 includes four caster wheels 12 (two are shown) to permit the device to be easily transported. Ease of mobility is particularly desirable to permit the device to be used for the treatment of several bins without requiring substantial disassembly or reassembly. The device 1 preferably is relatively light in weight, in one preferred embodiment weighing only about 175 lbs.

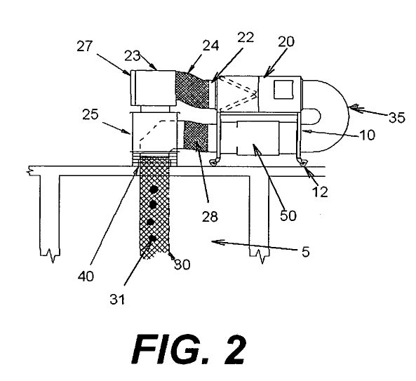

With reference to FIGS. 1A and 2, the apparatus includes an air handling device 20 for delivering heated air into the milling bin 5. Preferably, the air handling device 20 has a variable speed motor to permit airflow to be adjusted to meet the requirements of a particular application. Suitable airflow rates can be determined by persons skilled in the art with the aid of no more than routine experimentation and according to such considerations as bin depth and configuration as well as the properties of the agricultural material being treated, e.g., density and thermal coefficient. By way of example, higher airflows may be required to achieve greater uniformity of heating in deeper bins whereas lower airflows may suffice for bins having less depth. Airflows may vary over a wide range but usually range from about 500 to about 5,000 CFM and more often from about 1,000 to about 3,000 CFM. Airflows of about 2,500 CFM, particularly in combination with a heater having an output of about 250,000 BTU/hr, were found to be effective for treatment of conventionally sized flour milling bins. An example of a suitable air handling device is one available from Greenheck, model SQ-140-A, which operates on a 460 volt, three-phase electric motor.

The air handling device 20 has an air inlet 22 into which fresh and/or recirculated air is drawn. Preferably, incoming air is passed through an air filter (not shown) to reduce the risk of damaging the fan and heater from airborne debris. As illustrated in FIGS. 1A and 2, the air inlet 22 can be connected to a plenum 25 which fits over the filling port 40 or other opening of the milling bin 5. The plenum 25 may increase operation efficiency by reusing warm air which has been recirculated from the heating duct 30. In the embodiment illustrated in the drawings, an optional tee 23 is positioned between the plenum 25 and a flexible fitting 24. The tee 23 has an adjustable air damper 27 for selectively drawing outside air into the air inlet 22.

The air handling device 20 delivers a flow of air by a heater 50 and into a heating duct 30. In the embodiment illustrated in the drawings, the heater 50 is attached to the frame 10 and positioned below the air handling device 20. A U-shaped duct 35 connects the air handling device 20 and the heater 50. The illustrated U-shaped duct 35 is an 18″ non-insulated steel duct, although ducts of other dimensions and/or insulated ducts can be used if desired. The illustrated arrangement of the frame 10, heater 50, air handling device 20, and connecting duct 35 is designed to provide space efficiency and mobility. It should be understood that the various components such as the frame, heater, and air handling device can be positioned in a variety of different configurations without departing from the spirit of scope of the invention.

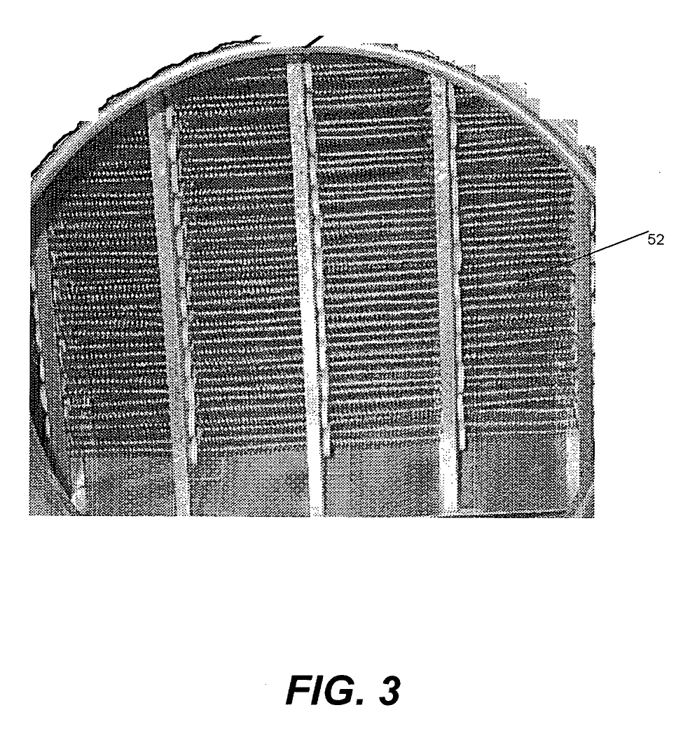

The heater 50 preferably is an electric heater, although heat may be provided by any suitable source such as combustible fuels, e.g., propane or oil, or other energy sources such as nuclear or solar energy. The output of the heater may vary over a wide range depending on such factors as the dimensions of the milling bin and the properties of the agricultural material therein. In general, the heater should be capable of heating air to a temperature of at least about 130° F., preferably at least about 140° F. The heater typically has an output of from about 100,000 to 500,000 BTU/hr and more usually from about 200,000 to 400,000 BTU/hr. An example of a suitable heater is a 70 KW electric heater available from Thermolec which has an output of 238,910 BTU/hr and is powered by a three-phase, 460 V motor at 88.2 amperes. The flow of air is heated as it passes through electrically heated coils 52 within the duct, as shown in FIG. 3.

The heating duct 30 preferably is designed to extend the depth of the milling bin 5, as illustrated in FIG. 2. The heating duct 30 illustrated in FIG. 2 has a diameter of 18 inches and a length of 70 feet. For ease of handling and storage, a flexible material, such as woven polyethylene or other fabric, may be used for constructing the heating duct 30. Fabrics preferably should be fire-retardant and temperature-resistant at least up to the temperatures to which the air is heated. Alternatively, the heating duct 30 may be constructed of steel, plastic, or other rigid material. A plurality of vent holes 31 may be positioned at points along the heating duct 30 to distribute heated air into the interior of the milling bin 5.

An important aspect of the mobile furnace described herein is the ability to achieve uniform or substantially uniform heating throughout the bin. The amount of time needed to terminate insects and other pests is inversely proportional to temperature. Insect mortality occurs primarily as a result of heat stress and dehydration, which occur more rapidly at higher temperatures. The following table summarizes approximate mortality times over a range of temperatures.

| Temperature (° F.) | Mortality Time | |
|---|---|---|
| 140 | 2 | sec. |
| 134 | 3 | min. |
| 122 | 10 | hr. |
| 113 | 3 | days |

If uniform heating is not achieved and portions of the agricultural material within the bin do not attain the target temperature, the efficacy of the treatment may be reduced (or longer treatment times may be needed). As illustrated in the table above, mortality times significantly increase as temperature decreases, particularly when temperatures decrease below about 130° F. Preferably, temperatures of at least about 130° F., more preferably at least about 135° F., and even more preferably at least about 140° F., are achieved throughout the bin to ensure complete or essentially complete mortality even during the course of relatively brief treatment periods. When the target temperatures of 130° F. or more are achieved, the treatment time usually is at least about one hour to ensure complete or essentially complete mortality.

Uniformity of temperature in the interior of the milling bin 5 can be achieved through a combination of several factors. The heating duct 30 preferably is designed to extend well into the milling bin 5, preferably into substantially the entire depth of the milling bin 5. Doing so helps ensure that flow of heated air is distributed throughout the depth of the milling bin 5, particularly to its lower regions, e.g., the portions furthest away from the heat source. The apparatus also includes a temperature controller. In its simplest form, the temperature controller is a thermostat for manually adjusting the temperature of the heater 50. Alternatively, the temperature controller is one capable of providing feedback control, such as a programmable logic controller. Temperature sensors (not shown) preferably are positioned at two or more positions along the length of the heating duct 30 and/or along the depth of the interior of the milling bin 5 so that temperatures at different lengths or depths can be measured.

The temperature sensors preferably electronically communicate with the controller, which can actuate any needed adjustments to airflow and/or temperature in response to the measured temperatures. If the temperature at the bottom of the milling bin 5 is lower than the target temperature, for example, the controller may cause the air handling device 20 to increase airflow to force more heated air toward the bottom of the milling bin 5. If the temperature is relatively uniform at the top and bottom of the milling bin 5 but is too high or too low, the controller can adjust the temperature of the heater 50 accordingly.

The apparatus also may be provided with various optional safety controls. For example, a pressure switch may be provided for detecting airflow. When the pressure switch detects zero airflow or airflow below a minimum threshold value, the pressure switch can cause the controller to cease operation of the heater 50. For instance, airflow would need to be detected before the heater 50 would be permitted to start, and airflow would need to be maintained to permit continued operation of the heater. Temperature safety controls also may be provided to prevent injury or thermal damage to the device or to the milling bin 5 or other nearby equipment. For example, the heater 50 can be designed for automatic shutdown if the measured temperature exceeds a preset value, such as 250° F. or 300° F.

### EXAMPLE

This example illustrates heat treating a flour milling bin whose dimensions are 10×10×70 ft. A flexible 70 ft. heating duct having approximately ½ inch vent holes positioned approximately every six inches, was inserted into the top of the milling bin and the temperature of the heater was set at 194° F. The air handling device was adjusted to deliver an airflow of 2,500 CFM. Temperatures were measured by temperature sensors positioned at the top and the bottom of the milling bin over the course of 12 hours. The following table lists the measured temperatures at various times.

| TIME | Temperature | Temperature |
|---|---|---|
| (hours) | Top (° F.) | Bottom (° F.) |
| 0 | 138 | 127 |
| 1 | 146 | 143 |
| 2 | 148 | 145 |
| 3 | 148 | 147 |
| 4 | 149 | 146 |
| 5 | 148 | 148 |
| 6 | 148 | 151 |
| 8 | 149 | 153 |
| 12 | 149 | 154 |

As shown above, these airflow and temperature settings were effective for achieving substantially uniform temperatures in a 10×10×70 ft. milling bin over the course of several hours. These temperatures are effective for insect and pest control in agricultural materials without the need for methyl bromide or other conventional chemical fumigants.

While particular embodiments of the present invention have been described and illustrated, it should be understood that the invention is not limited thereto since modifications may be made by persons skilled in the art. The present application contemplates any and all modifications that fall within the spirit and scope of the underlying invention disclosed and claimed herein.

1. A mobile apparatus for heat treating agricultural material in a milling bin for insect and pest control, the apparatus comprising:
(i) a frame having a plurality of wheels;
(ii) an air handling device having an inlet for receiving air and an outlet through which a flow of air is delivered;
(iii) a heater having a channel in fluid communication with the air handling device, wherein the heater is capable of heating air in the channel to a temperature of at least about 130° F.;
(iv) a conduit in fluid communication with the heater for delivering the flow of heated air into the interior of the milling bin; and
(v) a controller for maintaining an air temperature within the conduit effective for treating the agricultural material for insect and pest control.

2. The apparatus of claim 1 further comprising a plurality of temperature sensors for measuring temperature within at least one of the conduit and the interior of the milling bin, wherein the temperature sensors are in electronic communication with the controller.

3. The apparatus of claim 2, wherein the controller adjusts at least one of temperature and airflow, as necessary, in response to the measured temperatures.

4. The apparatus of claim 1 further comprising a pressure switch for detecting airflow, wherein the pressure switch causes the controller to cease operation of the heater if the detected airflow is lower than a minimum threshold value.

5. The apparatus of claim 1 wherein the heater comprises a plurality of electrically heated coils positioned in the channel, wherein air is heated by passing around the heated coils.

6. The apparatus of claim 1 wherein the air handling device has a variable speed motor which permits automatic or manual adjustment of airflow.

7. The apparatus of claim 1 wherein the conduit comprises an elongate duct adapted to extend into the interior of the milling bin.

8. The apparatus of claim 7 wherein the elongate duct comprises a plurality of vent holes through which heated air is passed into the interior of the milling bin.

9. The apparatus of claim 1 wherein the air handling device is capable of producing an airflow of from about 500 to about 5,000 CFM.

10. The apparatus of claim 9 wherein the air handling device is capable of producing an airflow of from about 1,000 to 3,000 CFM.

11. A mobile apparatus for heat treating agricultural material in a milling bin for insect and pest control, the apparatus comprising:
(i) a frame having a plurality of wheels;
(ii) an air handling device having an inlet for receiving air and an outlet through which a flow of air is delivered, wherein the air handling device is capable of producing an airflow of at least about 1,000 CFM;
(iii) an electric heater having a channel in fluid communication with the air handling device, wherein the heater has electric coils capable of heating air in the channel to a temperature of at least about 130° F.;
(iv) an elongate conduit in fluid communication with the heater for delivering the flow of heated air from the heater into the interior of the milling bin, wherein the elongate conduit is adapted to extend into the interior of the milling bin;
(v) a plenum to which the elongate conduit and the air inlet are connected; and
(vi) a controller for maintaining an air temperature within the conduit effective for treating the agricultural material for insect and pest control, wherein temperature sensors are provided for measuring temperature at a plurality of positions along the length of the elongate conduit or along the depth of the interior of the milling bin, or both, and wherein the controller adjusts at least one of temperature and airflow, as necessary, in response to the measured temperatures.

12. A method of treating agricultural material in a milling bin for insect and pest control, the method comprising:
(a) providing a mobile apparatus comprising:
(i) a frame having a plurality of wheels;
(ii) an air handling device having an inlet for receiving air and an outlet through which a flow of air is delivered;
(iii) a heater having a channel in fluid communication with the air handling device, wherein the heater is capable of heating air in the channel to a temperature of at least about 130° F.;
(iv) a conduit in fluid communication with the heater for delivering the flow of heated air into the interior of the milling bin; and
(v) a controller for maintaining an air temperature within the conduit which is sufficient for treating the agricultural material for insect and pest control;
(b) positioning the mobile apparatus in proximity of the milling bin;
(c) placing the conduit in communication with the interior of the milling bin so that heat can be transferred from the conduit to the interior of the milling bin; and
(d) providing a flow of heated air through the conduit at a temperature and for a time sufficient to treat agricultural material in the milling bin for insect and pest control.

13. The method of claim 12 wherein the conduit comprises an elongate duct, and wherein the step of placing the conduit in communication with the interior of the milling bin comprises inserting the elongate duct into the interior of the milling bin.

14. The method of claim 12 wherein the interior of the milling bin is heated to an average temperature of at least about 130° F.

15. The method of claim 14 wherein the interior of the milling bin is heated to an average temperature of at least about 140° F.

16. The method of claim 12 wherein the air handling device produces an airflow of from about 500 to about 5,000 CFM.

17. The method of claim 16 wherein the airflow is of from about 1,000 to 3,000 CFM.

18. The method of claim 12 wherein air is heated by passing the flow of air past electrically heated coils.

19. The method of claim 12 further comprising measuring temperature at a plurality of positions along the length of the conduit or along the depth of interior of the milling bin, or both, and adjusting at least one of temperature and airflow, as necessary, in response to the measured temperatures.

20. The method of claim 12 wherein the agricultural material is selected from the group consisting of rice, oats, wheat, milo, and flour.
